(19) United States
(12) Patent Application Publication
(10) Pub. No.: US 2024/0082908 A1
(43) Pub. Date: Mar. 14, 2024

(54) GAS PRESSURE CONTROL APPARATUS

(71) Applicant: UBE MACHINERY CORPORATION, LTD., Yamaguchi (JP)

(72) Inventor: Hiroaki Miyoshi, Yamaguchi (JP)

(21) Appl. No.: 18/264,882

(22) PCT Filed: Feb. 2, 2022
(86) PCT No.: PCT/JP2022/004010

§ 371 Date: Aug. 9, 2023

(30) Foreign Application Priority Data
Feb. 18, 2021 (JP) 2021-023868

(51) Int. Cl. B22D 39/06; B22D 18/04

(52) U.S. Cl. CPC B22D 39/06; B22D 18/04; B22D 18/08

(57) ABSTRACT

A gas pressure control apparatus that can control a pressure applied to a surface of molten metal with high accuracy. A gas pressure control apparatus includes a gas generation unit configured to generate nitrogen gas, and a pressure control unit configured to adjust a pressure of the nitrogen gas generated by the gas generation unit and to supply the nitrogen gas to a low-pressure casting apparatus. The pressure control unit includes a servo valve configured to control a flow rate of the nitrogen gas supplied from a tank and to cause the nitrogen gas to flow toward the low-pressure casting apparatus, and a pressure controller configured to adjust an opening degree of the servo valve based on a measured pressure Pm of the nitrogen gas supplied to the low-pressure casting apparatus.

### TECHNICAL FIELD

The present invention relates to a gas pressure control apparatus suitable for generating a differential pressure between an internal space of a holding furnace that holds molten metal and a cavity of a casting mold, to supply the molten metal in the holding furnace into the cavity.

### BACKGROUND ART

In an apparatus that performs casting by using a differential pressure between a holding furnace and a cavity of a casting mold, for example, in a low-pressure casting apparatus, after molten metal is supplied to the holding furnace and casting is repeated a predetermined number of shots, the molten metal is newly supplied to the holding furnace to prepare for next casting.

In the low-pressure casting apparatus, the molten metal is supplied in a batch manner. Therefore, when the number of shots in casting is increased, a molten metal surface in the holding furnace is lowered. Therefore, even when the pressure is sufficient to fill the cavity with the molten metal in a first shot, the pressure is reduced as the number of shots increases. Thus, for example, as disclosed in Patent Literature 1, it is necessary to perform subsequent casting with a corrected pressure obtained by increasing the pressure acting on the molten metal based on a lowering level of the molten metal surface. Accuracy of the corrected pressure influences quality of a cast product.

Patent Literature 2 discloses usage of a servo valve to control a gas pressure pressurizing a surface of the molten metal. Patent Literature 2 describes that the gas pressurization control servo valve can raise the gas pressure suitable for each of stages in filling of the cavity of the casting mold with the molten metal.

### CITATION LIST

### Patent Literature

Patent Literature 1: JP 2020-163399 A
Patent Literature 2: JP 2018-51566 A

### SUMMARY OF INVENTION

### Technical Problem

Therefore, an object of the present invention is to provide a gas pressure control apparatus that can control a pressure applied to a surface of molten metal with high accuracy.

### Solution to Problem

A gas pressure control apparatus according to the present invention includes a gas generation unit configured to generate nitrogen gas, and a pressure control unit configured to adjust a pressure of the nitrogen gas generated by the gas generation unit, and to supply the nitrogen gas to a low-pressure casting apparatus.

The gas generation unit includes a separator configured to separate and extract the nitrogen gas from taken-in air, and a tank configured to store the nitrogen gas extracted by the separator.

The pressure control unit includes a servo valve configured to control a flow rate of the nitrogen gas supplied from the tank and to cause the nitrogen gas to flow toward the low-pressure casting apparatus, and a pressure controller configured to adjust an opening degree of the servo valve based on a measured pressure of the nitrogen gas supplied to the low-pressure casting apparatus.

The pressure controller preferably compares the measured pressure with a target pressure of the nitrogen gas in the low-pressure casting apparatus, and adjusts the opening degree of the servo valve based on a difference between the measured pressure and the target pressure.

The pressure controller preferably holds casting pressure pattern data in which an elapsed time from start to completion of supply of the nitrogen gas to the low-pressure casting apparatus and the target pressure corresponding to the elapsed time are associated with each other, and compares the measured pressure with the casting pressure pattern data.

The pressure controller preferably holds the casting pressure pattern data corresponding to each of a plurality of types of molds used for the low-pressure casting apparatus. When the type of each mold among the plurality of types of molds is specified, the pressure controller preferably extracts the casting pressure pattern data corresponding to the mold, and compares the casting pressure pattern data with the measured pressure.

The pressure control unit preferably includes a pressure reducer configured to reduce the pressure of the nitrogen gas to be supplied to the servo valve and to cause the nitrogen gas to flow toward the servo valve.

The gas generation unit and the pressure control unit are preferably housed in a common housing.

In addition, the pressure control unit preferably further includes a flow path configured to control the flow rate of the nitrogen gas supplied from the tank and to cause the nitrogen gas to flow toward an object using the nitrogen gas, other than the low-pressure casting apparatus.

### Advantageous Effects of Invention

According to the present invention, it is possible to provide the gas pressure control apparatus that can control the pressure applied to the surface of the molten metal with high accuracy.

### BRIEF DESCRIPTION OF DRAWINGS

FIG. 1 is a block diagram illustrating a configuration of a gas pressure control apparatus according to an embodiment.

FIGS. 2A and 2B each show a control example of a gas pressure in a low-pressure casting apparatus in FIG. 3, FIG. 2A being a table showing an elapsed time from start to end of casting and a pressure of supplied gas, and FIG. 2B being a graph showing relationship between the elapsed time and the gas pressure.

FIG. 3 is a schematic cross-sectional view illustrating an example of the low-pressure casting apparatus to which the gas controlled in pressure by the gas pressure control apparatus in FIG. 1 is supplied.

FIG. 4 is an enlarged view of a main part in FIG. 3.

FIGS. 5A and 5B are diagrams illustrating a process of raising molten metal in the casting apparatus in FIG. 2.

FIGS. 6A and 6B are diagrams illustrating the process of raising the molten metal in the casting apparatus in FIG. 2, subsequent to FIGS. 5A and 5B.

FIG. 7 is a block diagram illustrating a configuration of a gas pressure control apparatus according to a first embodiment.

### DESCRIPTION OF EMBODIMENTS

An embodiment of the present invention is described below with reference to accompanying drawings.

A gas pressure control apparatus 1 according to the present embodiment controls a pressure of nitrogen gas separated from air supplied from a supply source, and supplies the nitrogen gas to a low-pressure casting apparatus 50 as an example of a supply destination. The gas pressure control apparatus 1 according to the present embodiment can control the pressure of the nitrogen gas with high accuracy by performing feedback control of a servo valve 23.

In the following, a configuration of the gas pressure control apparatus 1 and a configuration of the low-pressure casting apparatus 50 are described, and then, casting operation of the low-pressure casting apparatus 50 by the nitrogen gas with the controlled gas pressure is described.

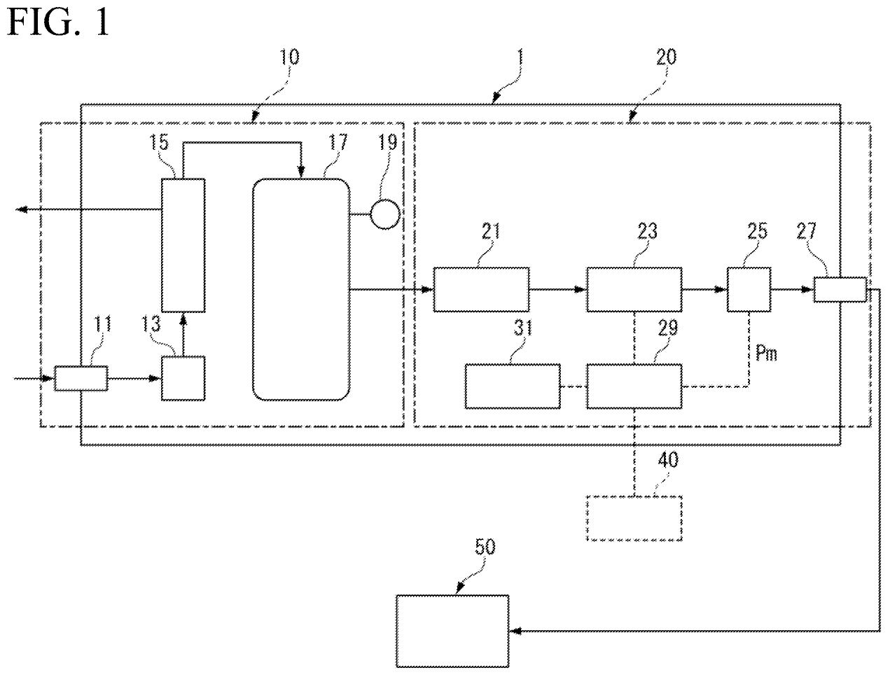

### [Gas Pressure Control Apparatus 1: FIG. 1]

As illustrated in FIG. 1, the gas pressure control apparatus 1 includes a gas generation unit 10 that generates the nitrogen gas by separating the nitrogen gas from the air, and a pressure control unit 20 that controls the pressure of the nitrogen gas generated by the gas generation unit 10.

The gas generation unit 10 includes a connection port 11 receiving the air from the supply source, an impurity remover 13 removing impurities from the air supplied from the connection port 11, a separator 15 separating the nitrogen gas from the air from which the impurities have been removed by the impurity remover 13, and a tank 17 storing the nitrogen gas separated by the separator 15. Note that, for example, the connection port 11 and the impurity remover 13 are connected by a pipe, and the impurity remover 13 and the separator 15 are connected by a pipe; however, in FIG. 1 and other drawings, the pipes are illustrated as arrows indicating directions of elements such as the air flowing through insides of the pipes.

As the supply source of the air, an air supply source with a compressor installed in a factory where the gas pressure control apparatus 1 and the low-pressure casting apparatus 50 are installed, is suitably used. The air supply source supplies the air compressed within a range of, for example, 0.2 MPa to 0.9 MPa.

The impurity remover 13 removes moisture, oil, and dust from the air. As the impurity remover 13, for example, a Reman dry filter is adopted. The Reman dry filter includes a first element separating, for example, moisture and oil from the compressed air, and a second element including a filter that further removes solid particles in addition to moisture and oil from the air from which moisture and oil has been separated by the first element.

As the separator 15, a separator of a separation membrane type, a PSA (Pressure Swing Adsorption) type, or a cryogenic type can be adopted as an example.

The separation membrane-type separator includes a separation membrane including, for example, a bundle of polyimide hollow yarns. When the compressed air is supplied to the separation membrane, the air is separated into nitrogen gas and other gas in a process of passing through insides of the hollow yarns.

The PSA-type gas separator includes an oxide PSA-type gas separator that extracts oxygen from the air and a nitrogen PSA-type gas separator that extracts nitrogen from the air. In the present embodiment, the nitrogen PSA-type gas separator is adopted. The nitrogen PSA-type gas separator uses difference in absorption speed between oxygen and nitrogen, by an absorption agent (Molecular Sieving Carbon) made of a kind of activated carbon. In other words, pressurized air is sent to an adsorption tank filled with the absorption agent, oxygen is caused to be preferentially absorbed to the absorption agent. As a result, high-purity nitrogen is separated from the air and is taken out from the adsorption tank.

The cryogenic-type separator 15 cools the air, liquefies nitrogen (boiling point=−195.8° C.), oxygen (boiling point=−183° C.), and argon (boiling point=−185.7° C.), and extracts high-purity gas by difference in the boiling point.

Nitrogen separated from oxygen and the like by the separator 15 is stored in the tank 17, and is supplied to the low-pressure casting apparatus 50 based on open/close operation of the servo valve 23. An oxygen concentration meter 19 measuring an oxygen amount contained in the nitrogen gas stored in the tank 17 is provided in the tank 17. A measurement result of the oxygen concentration meter 19 is sent to the separator 15.

The oxygen concentration meter 19 is provided for the following first object and second object.

First object: to show a rough replacement indication of the separator 15.

When the concentration of oxygen contained in the separated nitrogen gas is increased to a predetermined value or more, it is presumed that the separator 15 has reached its lifetime. In this case, the separator 15 is replaced.

Second object: to adjust an amount of air supplied to the separator 15.

In the separator 15 of the separation membrane type or the PSA type, the concentration of oxygen is changed based on the air supply amount. More specifically, when the air supply amount is large, the oxygen concentration is high. This is because oxygen molecules that cannot be separated and adsorbed forcibly pass through the separator 15. In contrast, when the air supply amount is small, the oxygen concentration is reduced. In this case, a passage amount of the nitrogen gas is also reduced. Therefore, when the oxygen concentration is measured, the oxygen concentration can be suppressed, and a necessary amount of nitrogen gas can be supplied to the tank 17.

### [Pressure Control Unit 20: FIG. 1]

As illustrated in FIG. 1, the pressure control unit 20 includes a pressure reducer 21 that reduces the pressure of the nitrogen gas supplied from the tank 17 to a desired pressure, and a servo valve 23 that adjusts a flow rate of the nitrogen gas reduced in pressure by the pressure reducer 21 and causes the nitrogen gas to flow toward a downstream side. The pressure control unit 20 includes a pressure gauge 25 that detects the pressure of the nitrogen gas flowing from the servo valve 23, and a discharge port 27 that discharges the nitrogen gas having passed through the pressure gauge 25, toward the low-pressure casting apparatus 50. The pressure control unit 20 includes a pressure controller 29 that adjusts an opening degree of the servo valve 23 to control the pressure of the nitrogen gas flowing from the servo valve 23 toward the downstream side, and a setter 31 that sets the pressure of the nitrogen gas controlled by the pressure controller 29.

The pressure reducer 21 adjusts the pressure of the nitrogen gas stored in the tank 17 to 0.1 MPa to 0.3 MPa as an example, and causes the nitrogen gas to flow toward the servo valve 23. The pressure is a value suitable for adjusting the pressure of the nitrogen gas necessary for the low-pressure casting apparatus 50. Specific means of the pressure reducer 21 is not limited as long as the pressure reducer 21 can adjust the pressure.

The servo valve 23 adjusts the pressure of the nitrogen gas based on change in pressure of the nitrogen gas inside a pressurizing chamber 70 storing the molten metal of the low-pressure casting apparatus 50 described below, and causes the nitrogen gas to flow toward the downstream side.

The servo valve 23 can control adjustment of the pressure with high accuracy in multiple stages by adjusting the flow rate of the nitrogen gas. The pressure of the nitrogen gas inside the pressurizing chamber 70 is slightly changed by rise of the molten metal, change in height of the molten metal surface, temperatures inside the pressurizing chamber 70 and a stalk 80, and the like. On the other hand, to produce a cast product having high quality by the low-pressure casting apparatus 50, the change in pressure is desirably corrected, and a flow velocity of the molten metal coincident with or approximate to necessary ideal change in pressure is desirably achieved. Therefore, the gas pressure control apparatus 1 adjusts the pressure of the nitrogen gas supplied to the low-pressure casting apparatus 50 and controls the flow velocity of the molten metal by using the servo valve 23. The control of the molten metal is performed inside a mold based on a shape and a dimension of the cast product.

The pressure gauge 25 is provided on the downstream of the servo valve 23, and measures the pressure of the nitrogen gas flowing from the servo valve 23. A measured pressure Pm is provided to the pressure controller 29.

The pressure controller 29 adjusts the opening degree of the servo valve 23 based on the measured pressure Pm of the nitrogen gas measured by the pressure gauge 25. The adjustment is performed by feedback control by comparison of the measured pressure Pm with a casting pressure pattern that is held by the pressure controller 29 and is set for the cast product casted by the low-pressure casting apparatus 50. Therefore, the pressure controller 29 holds data on the casting pressure pattern. The data on the casting pressure pattern (hereinafter, simply referred to as casting pressure pattern) is data in which an elapsed time Tc from start to end of casting and a set target pressure Pt of the nitrogen gas are associated with each other for the cast product.

The casting pressure pattern is set for each of types of the cast products different in dimension and shape. The cast product and the mold unambiguously correspond to each other. Therefore, the pressure controller 29 stores the casting pressure pattern in association with a plurality of types of molds.

Note that the operation of the pressure controller 29 is controlled by an upper control apparatus 40 in some cases. The upper control apparatus 40 also controls operation of the low-pressure casting apparatus 50 in some cases. Further, the opening degree of the servo valve 23 can be adjusted based on an external pressure gauge, for example, a pressure gauge installed in the low-pressure casting apparatus 50. In a case where a pipe connecting the discharge port 27 and the low-pressure casting apparatus 50 is long, the measures are necessary to avoid response delay.

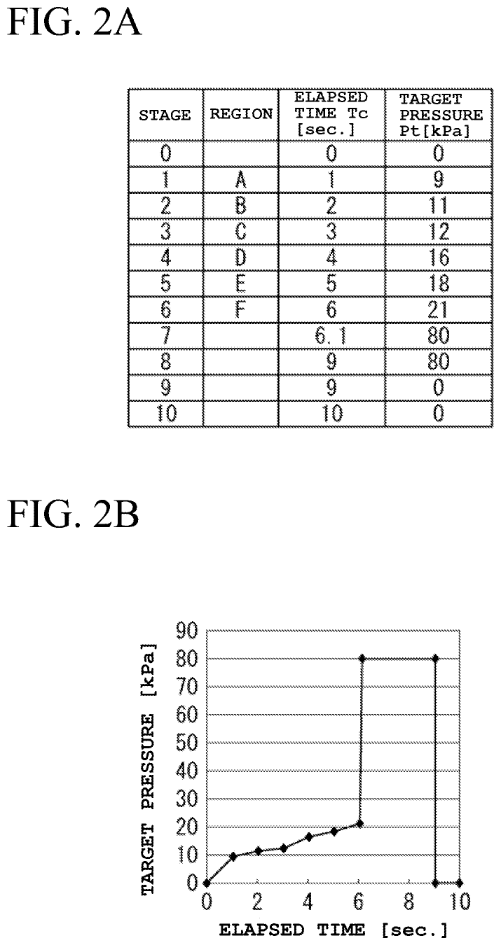

An example of the casting pressure pattern is described with reference to FIGS. 2A and 2B.

In this example, as shown in FIGS. 2A and 2B, the casting from start to end is divided into 11 stages from a zero-th stage at start of the casting to a tenth stage at completion of the casting. Further, the elapsed time Tc from start of the casting and the target pressure Pt of the nitrogen gas are associated to each of the 11 stages. For example, in the first stage, the elapsed time Tc from start of the casting of 1 sec. is associated with the target pressure Pt of the nitrogen gas of 9 kPa. In the fifth stage, the elapsed time Tc from start of the casting of 5 sec. is associated with the target pressure Pt of the nitrogen gas of 18 kPa. Further, in the seventh stage, the elapsed time Tc from start of the casting of 5 sec. is associated with the target pressure Pt of the nitrogen gas of 80 kPa, and in the ninth stage, the elapsed time Tc from start of the casting of 9 sec. is associated with the target pressure Pt of the nitrogen gas of 0 kPa.

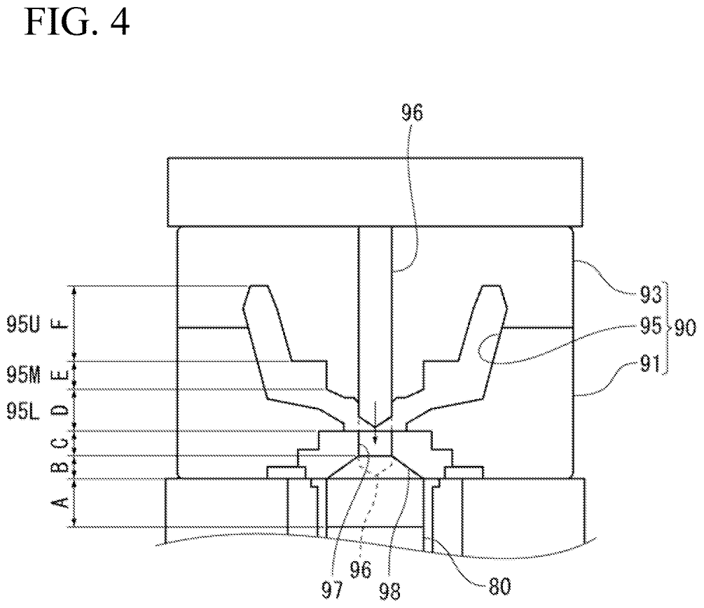

Note that the casting pressure pattern in FIG. 2A includes regions A to F in the stalk 80 of the low-pressure casting apparatus 50 and a cavity 95 of a mold 90, which makes it possible to understand the process in which molten metal M passes through the regions A to F. The regions A to F are illustrated in FIG. 4.

The casting pressure pattern is adjusted based on change in passing cross-sectional area of a flow path through which the molten metal M passes. The passing cross-sectional area is changed among the regions A to F as described below. The flow path through which the molten metal M passes used herein includes the stalk 80, a runner 98, a sprue 97, and the cavity 95.

In the first stage (region A), the inside of the stalk 80 serve as the flow path of the molten metal M, and the passing cross-sectional area thereof is AA that is fixed. The relationship between the elapsed time Tc and the target pressure Pt of the nitrogen gas in the first stage (region A) is specified by the following expression (1) in FIGS. 2A and 2B. In the expression (1), “A” is a coefficient in the region A. In expressions (2), (3), and other expressions, “B”, “C”, and the like are also coefficients.

Pt=A×Tc expression (1)

0≤Pt≤9 (kPa), 0<Tc≤1 (sec.)

The second stage (region B) corresponds to the runner 98 (see FIG. 4) for the molten metal M at the lowest end inside a fixed mold 91, and communicates with an upper limit position of the region A. The passing cross-sectional area thereof is A_{B} that is reduced from a lower limit position toward an upper limit position. The relationship between the elapsed time Tc and the target pressure Pt in the second stage (region B) is specified by the following expression (2) in FIGS. 2A and 2B.

Pt=B×Tc expression (2)

9<Pt≤11 (kPa), 1<Tc≤2 (sec.)

As illustrated in FIG. 2B, the pressure from the first stage to the second stage is proportional to the elapsed time and is linearly increased; however, this is merely an example. For example, the pressure in the section may be increased in a curved shape or may be gradually increased in a stepwise manner.

The third stage (region C) corresponds to the sprue 97 (see FIG. 4) for the molten metal M inside the fixed mold 91, and communicates with the upper limit position of the region B. The passing cross-sectional area thereof is A_{C} that is fixed. The relationship between the elapsed time Tc and the target pressure Pt in the third stage (region C) is specified by the following expression (3) in FIGS. 2A and 2B.

Pt=C×Tc expression (3)

11<Pt≤12 (kPa), 2<Tc≤3 (sec.)

The fourth stage (region D) corresponds to a lower cavity 95L of the cavity 95 inside the fixed mold 91, and communicates with an upper limit position of the region C. The passing cross-sectional area thereof is A_{D} that is increased from a lower limit position toward an upper limit position. The relationship between the elapsed time Tc and the target pressure Pt in the fourth stage (region D) is specified by the following expression (4) in FIGS. 2A and 2B.

Pt=D×Tc expression (4)

12<Pt≤16 (kPa), 3<Tc≤4 (sec.)

The fifth stage (region E) corresponds to a center cavity 95M of the cavity 95 inside the fixed mold 91, and communicates with the upper limit position of the region D. The passing cross-sectional area thereof is A E that is increased from a lower limit position toward an upper limit position. The relationship between the elapsed time Tc and the target pressure Pt in the fifth stage (region E) is specified by the following expression (5) in FIGS. 2A and 2B.

Pt=E×Tc expression (5)

16<Pt≤18 (kPa), 4<Tc≤5 (sec.)

The sixth stage (region F) corresponds to an upper cavity 95U of the cavity 95 over the inside of the fixed mold 91 and a movable mold 93, and communicates with the upper limit position of the region E. The passing cross-sectional area thereof is A_{F} that is increased from a lower limit position toward an upper limit position. The relationship between the elapsed time Tc and the target pressure Pt in the sixth stage (region F) is specified by the following expression (6) in FIGS. 2A and 2B. Note that, in the present embodiment, the cavity 95 formed between the fixed mold 91 and the movable mold 93 is filled with the molten metal M in the sixth stage.

Pt=F×Tc expression (6)

18<Pt≤21 (kPa), 5<Tc≤6 (sec.)

The seventh stage and the eighth stage correspond to a first pressure holding step of continuing pressurization by the nitrogen gas at a high pressure, for example, at 80 MPa after filling with the molten metal M, to cause a riser effect against solidification shrinkage of the molten metal M. At the same time, a center pin 96 is moved downward to close the sprue 97 as illustrated by a dashed line in FIG. 4. The relationship between the elapsed time Tc and the target pressure Pt in the seventh stage and the eighth stage are specified by the following expressions (7) and (8) in FIGS. 2A and 2B.

### Seventh Stage

Pt=G×Tc expression (7)

21<Pt≤80 (kPa), 6<Tc≤6.1 (sec.)

### Eighth Stage

Pt=G expression (8)

Pt=80 (kPa), 6.1<Tc≤9 (sec.)

In the ninth stage and the tenth stage, after downward movement of the center pin 96 is completed, the target pressure Pt is reduced to zero. As a result, a second pressure holding step of lowering the surface of the molten metal M in the stalk 80, and pressurizing the molten metal M in the cavity 95 by using an unillustrated pressurization mechanism incorporated in the mold 90, is performed. The second pressure holding step complements lack in the first pressure holding step performed only by the pressure of the gas. The relationship between the elapsed time Tc and the target pressure Pt in the ninth stage and the tenth stage are specified by the following expressions (9) and (10) in FIGS. 2A and 2B.

### Ninth Stage

Pt=0(kPa) expression (9)

Tc=9 (sec.)

### Tenth Stage

Pt=0(kPa) expression (10)

9<Tc≤10 (sec.)

When the passing cross-sectional area of the molten metal M according to the present embodiment is changed, namely, when the region shifts from the region A to the region B, when the region shifts from the region B to the region C, when the region shifts from the region C to the region D, when the region shifts from the region D to the region E, and when the region shifts from the region E to the region F, the target pressure Pt of the nitrogen gas is changed.

As described above, the target pressure Pt of the nitrogen gas is changed when the passing cross-sectional area of the flow path of the molten metal M changes, for the following first to fourth objects.

First object: to appropriately control the flow velocity of the molten metal based on the passing cross-sectional area, and to prevent a casting failure caused by turbulence of the molten metal, for example, air inclusion.

Second object: to cope with deterioration of flowability of the molten metal M due to air remaining in the cavity 95 of the mold 90 as a resistance. For example, the remaining air is gradually compressed to inhibit the flow of the molten metal with flow progress of the molten metal M. In particular, after the molten metal M passes through a split surface of the mold 90, the number of positions where the air is released is reduced, and necessity of coping action is accordingly increased. Further, for example, adding vacuum suction of the mold 90 makes it possible to reduce the air resistance.

Third object: to resist increase in flow resistance by increasing viscosity of the molten metal M with temperature drop of the molten metal M.

Fourth object: to resist application of a weight of the molten metal M with rise by filling progress of the molten metal M. This corresponds to a case of vertical casting.

Next, the feedback control of the servo valve 23 by the pressure controller 29 is described.

In the feedback control, the measured pressure Pm of the nitrogen gas obtained by the pressure gauge 25 is compared with the casting pressure pattern, and the opening degree of the servo valve 23 is adjusted such that the measured pressure Pm is coincident with the target pressure Pt of the casting pressure pattern.

For example, during the first stage, namely, during the elapsed time Tc of 0<Tc≤1, the measured pressure Pm and the target pressure Pt by the expression (1) are compared with each other. The comparison is performed by the pressure controller 29. When the measured pressure Pm is greater than the target pressure Pt, the pressure controller 29 closes the servo valve 23 by a degree corresponding to a difference therebetween. When the measured pressure Pm is less than the target pressure Pt, the pressure controller 29 opens the servo valve 23 by the degree corresponding to the difference therebetween. Further, when the measured pressure Pm is coincident with the target pressure Pt, the pressure controller 29 maintains the opening degree of the servo valve 23.

The comparison between the measured pressure Pm and the target pressure Pt can also be performed by setting a threshold to the target pressure Pt. For example, a threshold of ±0.2 kPa is added to the target pressure Pt of 9 kPa in the first stage, to set the target pressure Pt to be compared with the measured pressure Pm to a range of 8.8 kPa to 9.2 kPa. In this case, when the measured pressure Pm is within the range of 8.8 kPa to 9.2 kPa, the pressure controller 29 determines that the measured pressure Pm is coincident with the target pressure Pt. Further, when the measured pressure Pm is less than 8.8 kPa, the pressure controller 29 opens the servo valve 23 because the measured pressure Pm is less than the target pressure Pt. When the measured pressure Pm exceeds 9.2 kPa, the pressure controller 29 closes the servo valve 23 because the measured pressure Pm is greater than the target pressure Pt.

In the second stage and the subsequent stages, the measured pressure Pm and the target pressure Pt can be compared in a similar manner, to adjust the opening degree of the servo valve 23.

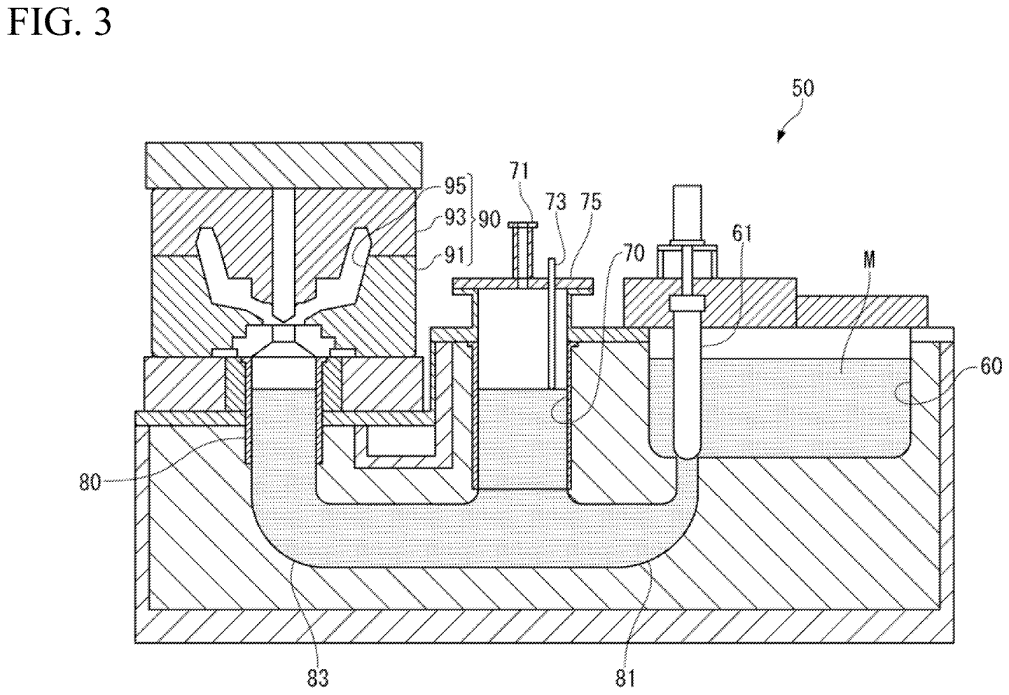

### [Low-Pressure Casting Apparatus 50: FIG. 3 and FIG. 4]

Next, an example of the low-pressure casting apparatus 50 is described with reference to FIG. 3 and FIG. 4.

As illustrated in FIG. 3, the low-pressure casting apparatus 50 includes a holding furnace 60 holding the molten metal M, the pressurizing chamber 70 that communicates with the holding furnace 60 through a first communication path 81 and holds the molten metal M supplied from the holding furnace 60, and the stalk 80 communicating with the pressurizing chamber 70 through a second communication path 83.

An upper end of the stalk 80 is connected to an opening of the fixed mold 91 communicating with the cavity 95 of the mold 90 that includes the fixed mold 91 and the movable mold 93, and supplies the molten metal M into the cavity 95. Each of the holding furnace 60, the first communication path 81, and the second communication path 83 is provided with an unillustrated heater that heats the molten metal M to a temperature of about 500° C. to about 700° C. necessary for maintaining the molten state.

As illustrated in FIG. 3, the holding furnace 60 is provided with a stopper 61 that controls supply of the molten metal M to the pressurizing chamber 70. In a beginning state in a casting step, the stopper 61 opens/closes an inlet to the first communication path 81 of the holding furnace 60 such that a constant amount of molten metal M is constantly stored in the pressurizing chamber 70.

As illustrated in FIG. 3, an upper end opening portion of the pressurizing chamber 70 is closed by a lid 75, and a space above the surface of the molten metal M inside the pressurizing chamber 70 is a sealed space. The gas pressure control apparatus 1 is connected to the sealed space through a gas introduction port 71. The gas pressure control apparatus 1 supplies the nitrogen gas into the pressurizing chamber 70 through the gas introduction port 71. Further, the rid 75 is provided with a molten metal surface detection rod 73 that is installed toward a liquid surface of the molten metal M. The molten metal surface detection rod 73 detects whether a surface level of the molten metal M in the pressurizing chamber 70 has reached a predetermined level when the molten metal M is supplied from the holding furnace 60 to the pressurizing chamber 70.

### [Casting Operation of Low-Pressure Casting Apparatus 50:

### FIGS. 2A, 2B, FIGS. 5A, 5B, and FIGS. 6A, 6B]

Next, casting operation of the low-pressure casting apparatus 50 is described with reference to FIGS. 2A, 2B, FIGS. 5A, 5B, and FIGS. 6A, 6B.

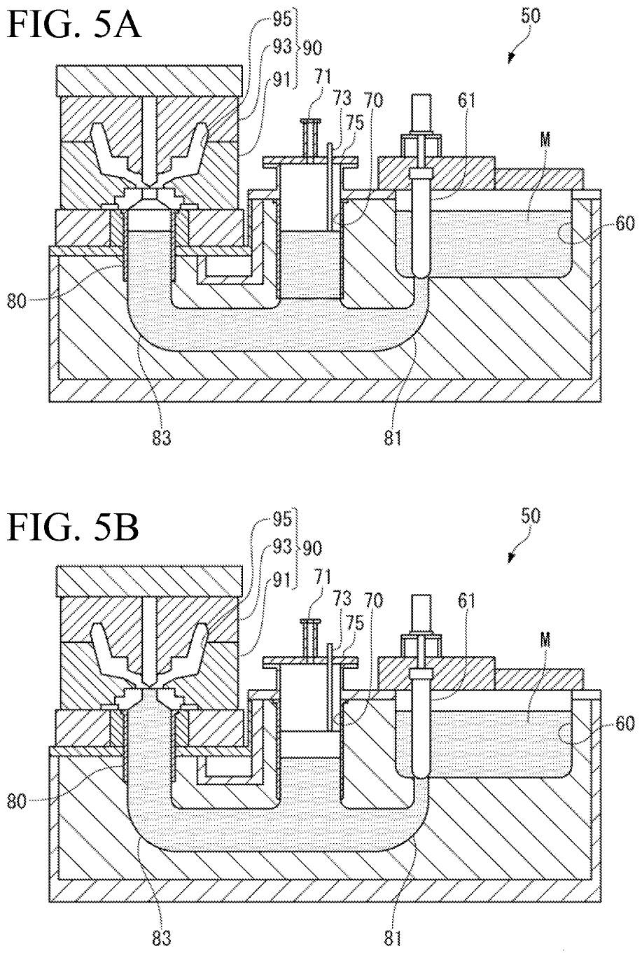

FIG. 5A illustrates a casting start time point corresponding to a state in the zero-th stage in FIGS. 2A and 2B.

At a time point when the elapsed time after start of casting reaches 1 sec., the opening degree of the servo valve 23 is adjusted such that the target pressure Pt becomes 9 kPa. Next, at a time point when the elapsed time reaches 2 sec., the opening degree of the servo valve 23 is controlled such that the target pressure Pt becomes 11 kPa. Next, at a time point when the elapsed time reaches 3 sec., the opening degree of the servo valve 23 is controlled such that the target pressure Pt becomes 12 kPa. At the time point, as illustrated in FIG. 5B and FIG. 4, the surface of the molten metal M reaches the lower limit of the region D.

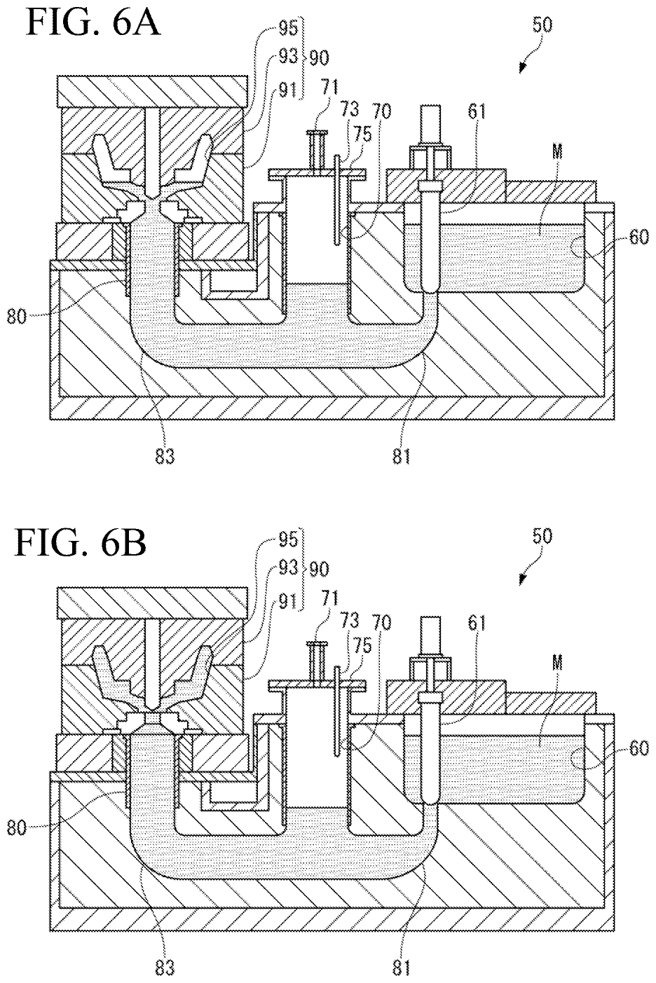

Next, at a time point when the elapsed time reaches 4 sec., the opening degree of the servo valve 23 is controlled such that the target pressure Pt becomes 16 kPa. In addition, at a time point when the elapsed time reaches 5 sec., the opening degree of the servo valve 23 is controlled such that the target pressure Pt becomes 18 kPa. At the time point, as illustrated in FIG. 6A and FIG. 4, the surface of the molten metal M reaches the lower limit of the region F. Further, at a time point when the elapsed time reaches 6 sec., the opening degree of the servo valve 23 is controlled such that the target pressure Pt becomes 21 kPa. At the time point, as illustrated in FIG. 6B and FIG. 4, the surface of the molten metal M reaches the upper limit of the region F, namely, the cavity 95 is filled with the molten metal M, and the surface of the molten metal M reaches the upper limit of the cavity 95.

The opening degree of the servo valve 23 is adjusted such that the target pressure Pt becomes 80 kPa until the elapsed time becomes 6.1 sec. after the surface of the molten metal M reaches the upper limit of the region F. The state with the pressure of 80 kPa is continued until the elapsed time becomes 9 sec. The step is performed in order to provide the above-described riser effect to the molten metal M.

After the elapsed time becomes 9 sec. and the riser step ends, the servo valve 23 is closed such that the target pressure Pt becomes zero, and supply of the nitrogen gas is stopped.

### [Effects]

Next, effects by the gas pressure control apparatus 1 according to the present embodiment are described.

In the gas pressure control apparatus 1, the pressure of the nitrogen gas in filling with the molten metal and casting in the low-pressure casting apparatus 50 can be controlled by the feedback control of the servo valve 23. Therefore, according to the gas pressure control apparatus 1, it is possible to control the pressure of the nitrogen gas in the multiple stages with high accuracy. The stable quality of the cast product manufactured by the low-pressure casting apparatus 50 can be achieved through the high-accuracy control.

Further, according to the gas pressure control apparatus 1, the target pressure Pt is changed based on change in the passing cross-sectional area of the flow path of the molten metal M supplied to the mold 90. This makes it possible to control the pressure of the nitrogen gas suitable for the cast product with high accuracy.

Further, the gas pressure control apparatus 1 can be connected to the low-pressure casting apparatus 50 and used because the gas pressure control apparatus 1 includes the gas generation unit 10 generating the nitrogen gas and the pressure control unit 20 controlling the pressure of the generated nitrogen gas. When the air supplied in the factory is used as a generation source of the nitrogen gas, the gas pressure control apparatus 1 can control the pressure of the nitrogen gas without addition of the other components such as a nitrogen gas cylinder. In other words, the gas pressure control apparatus 1 has a completed apparatus configuration. Further, when the gas generation unit 10 and the pressure control unit 20 are incorporated in and housed in a single common housing, use of the gas pressure control apparatus 1 can be rapidly started by moving and connecting the gas pressure control apparatus 1 to a using position.

Although the present embodiment is described above, the configurations described in the above-described embodiment can be selected or appropriately modified to the other configurations without departing from the gist of the present invention.

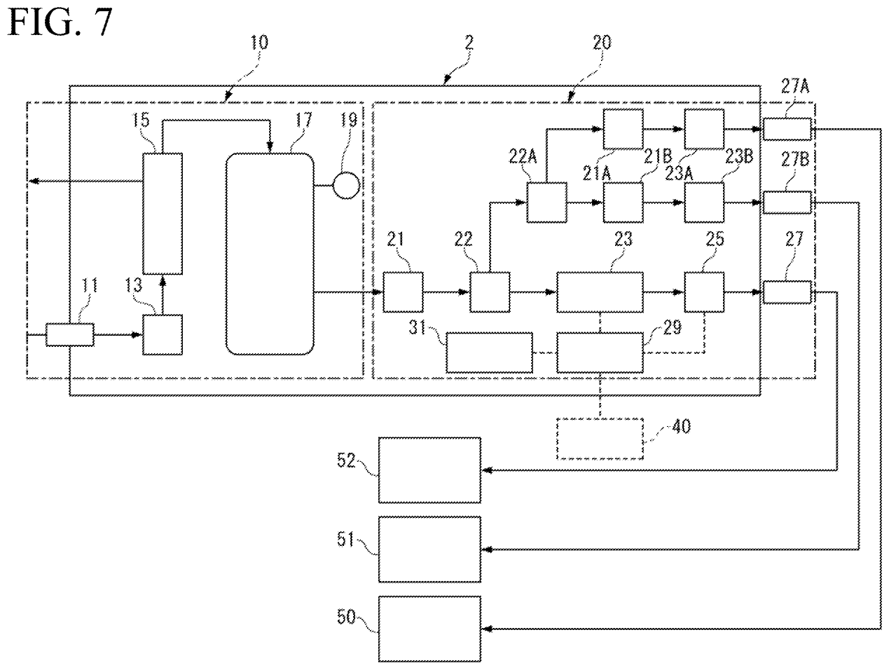

As an example, a gas pressure control apparatus 2 illustrated in FIG. 7 is described.

The gas pressure control apparatus 2 includes a distributor 22 between the pressure reducer 21 and the servo valve 23 of the gas pressure control apparatus 1, thereby achieving use of the nitrogen gas in other apparatuses and the like of the low-pressure casting apparatus 50.

The gas pressure control apparatus 2 further includes a distributor 22A in a flow path branched from the distributor 22, to branch the flow path into two flow paths toward more downstream side than the distributor 22A. Further, pressure reducers 21A and 21B are provided in the respective flow paths, and flow rate control valves 23A and 23B are provided on the downstream sides of the respective pressure reducers 21A and 21B. Connection ports 27A and 27B are provided on the downstream sides of the respective flow rate control valves 23A and 23B, to supply the nitrogen gas toward the other objects using the nitrogen gas. Examples of other objects include use of the nitrogen gas to lower the molten metal M inside the stalk 80 of the low-pressure casting apparatus 50, and use for degassing treatment and oxidation prevention treatment of the molten metal M.

In the pressure control apparatus 2 illustrated in FIG. 7, the distributor 22A and the components provided on the downstream side thereof are different from the servo valve 23 and the subsequent components of the pressure control apparatus 1; however, in the present invention, a plurality of servo valves 23 and the subsequent components can also be provided.

### REFERENCE SIGNS LIST

1 gas pressure control apparatus
10 gas generation unit
11 connection port
13 impurity remover
15 separator
17 tank
19 oxygen concentration meter
20 pressure control unit
21 pressure reducer
22 distributor
23 servo valve
25 pressure gauge
27 discharge port
29 pressure controller
31 setter
40 control apparatus
50 low-pressure casting apparatus
60 holding furnace
61 stopper
70 pressurizing chamber
71 gas introduction port
73 molten metal surface detection rod
75 lid
80 stalk
90 mold
91 fixed mold
93 movable mold
95 cavity
96 center pin
97 sprue
98 runner
M molten metal

1. A gas pressure control apparatus, comprising:
a gas generation unit configured to generate nitrogen gas; and
a pressure control unit configured to adjust a pressure of the nitrogen gas generated by the gas generation unit, and to supply the nitrogen gas to a low-pressure casting apparatus, wherein
the gas generation unit includes a separator configured to separate and extract the nitrogen gas from taken-in air, and a tank configured to store the nitrogen gas extracted by the separator, and
the pressure control unit includes a servo valve configured to control a flow rate of the nitrogen gas supplied from the tank and to cause the nitrogen gas to flow toward the low-pressure casting apparatus, and a pressure controller configured to adjust an opening degree of the servo valve based on a measured pressure of the nitrogen gas supplied to the low-pressure casting apparatus.

2. The gas pressure control apparatus according to claim 1, wherein the pressure controller compares the measured pressure with a target pressure of the nitrogen gas in the low-pressure casting apparatus, and adjusts the opening degree of the servo valve based on a difference between the measured pressure and the target pressure.

3. The gas pressure control apparatus according to claim 2, wherein the pressure controller holds casting pressure pattern data in which an elapsed time from start to completion of supply of the nitrogen gas to the low-pressure casting apparatus and the target pressure corresponding to the elapsed time are associated with each other, and compares the measured pressure with the casting pressure pattern data.

4. The gas pressure control apparatus according to claim 3, wherein
the pressure controller holds the casting pressure pattern data corresponding to each of a plurality of types of molds used for the low-pressure casting apparatus, and
when the type of each mold among the plurality of types of molds is specified, the pressure controller extracts the casting pressure pattern data corresponding to the mold, and compares the casting pressure pattern data with the measured pressure.

5. The gas pressure control apparatus according to claim 1, wherein the pressure control unit includes a pressure reducer configured to reduce the pressure of the nitrogen gas to be supplied to the servo valve and to cause the nitrogen gas to flow toward the servo valve.

6. The gas pressure control apparatus according to claim 1, wherein the gas generation unit and the pressure control unit are housed in a common housing.

7. The gas pressure control apparatus according to claim 1, wherein the pressure control unit further includes a flow path configured to control the flow rate of the nitrogen gas supplied from the tank and to cause the nitrogen gas to flow toward an object using the nitrogen gas, other than the low-pressure casting apparatus.

8. The gas pressure control apparatus according to claim 2, wherein the pressure control unit includes a pressure reducer configured to reduce the pressure of the nitrogen gas to be supplied to the servo valve and to cause the nitrogen gas to flow toward the servo valve.

9. The gas pressure control apparatus according to claim 3, wherein the pressure control unit includes a pressure reducer configured to reduce the pressure of the nitrogen gas to be supplied to the servo valve and to cause the nitrogen gas to flow toward the servo valve.

10. The gas pressure control apparatus according to claim 4, wherein the pressure control unit includes a pressure reducer configured to reduce the pressure of the nitrogen gas to be supplied to the servo valve and to cause the nitrogen gas to flow toward the servo valve.

11. The gas pressure control apparatus according to claim 2, wherein the gas generation unit and the pressure control unit are housed in a common housing.

12. The gas pressure control apparatus according to claim 3, wherein the gas generation unit and the pressure control unit are housed in a common housing.

13. The gas pressure control apparatus according to claim 4, wherein the gas generation unit and the pressure control unit are housed in a common housing.

14. The gas pressure control apparatus according to claim 5, wherein the gas generation unit and the pressure control unit are housed in a common housing.

15. The gas pressure control apparatus according to claim 2, wherein the pressure control unit further includes a flow path configured to control the flow rate of the nitrogen gas supplied from the tank and to cause the nitrogen gas to flow toward an object using the nitrogen gas, other than the low-pressure casting apparatus.

16. The gas pressure control apparatus according to claim 3, wherein the pressure control unit further includes a flow path configured to control the flow rate of the nitrogen gas supplied from the tank and to cause the nitrogen gas to flow toward an object using the nitrogen gas, other than the low-pressure casting apparatus.

17. The gas pressure control apparatus according to claim 4, wherein the pressure control unit further includes a flow path configured to control the flow rate of the nitrogen gas supplied from the tank and to cause the nitrogen gas to flow toward an object using the nitrogen gas, other than the low-pressure casting apparatus.

18. The gas pressure control apparatus according to claim 5, wherein the pressure control unit further includes a flow path configured to control the flow rate of the nitrogen gas supplied from the tank and to cause the nitrogen gas to flow toward an object using the nitrogen gas, other than the low-pressure casting apparatus.

19. The gas pressure control apparatus according to claim 6, wherein the pressure control unit further includes a flow path configured to control the flow rate of the nitrogen gas supplied from the tank and to cause the nitrogen gas to flow toward an object using the nitrogen gas, other than the low-pressure casting apparatus.
